(19) United States
(12) Patent Application Publication
(10) Pub. No.: US 2021/0027930 A1
(43) Pub. Date: Jan. 28, 2021

(54) REACTOR CORE, REACTOR, AND METHOD FOR MANUFACTURING REACTOR CORE

(71) Applicant: Komatsu Ltd., Tokyo (JP)

(72) Inventors: Makoto CHIBA, Tokyo (JP); Shin YOSHIDA, Tokyo (JP); Shoji AOKI, Tokyo (JP); Hiromasa KAIBE, Tokyo (JP)

(21) Appl. No.: 17/041,191

(22) PCT Filed: Nov. 21, 2018
(86) PCT No.: PCT/JP2018/042996

§ 371 Date: Sep. 24, 2020

(30) Foreign Application Priority Data
Mar. 29, 2018 (JP) 2018065177

(51) Int. Cl. H01F 27/255; H01F 41/02

(52) U.S. Cl. CPC H01F 27/255; H01F 41/0246

(57) ABSTRACT

Provided is a reactor core (20) comprising: a plurality of inner core portions (21) that includes a plurality of first powder magnetic cores (23), the plurality of first powder magnetic cores (23) being arranged in line in a first direction (Dx), and each having a first end surface (21ta) and a second end surface (21tb) at both ends in the first direction (Dx); and two outer core portions (22) that includes second powder magnetic cores (26), the external dimensions of which correspond to the first powder magnetic cores 23, and that are respectively arranged so as to extend over the first end surfaces (21ta) adjacent in a second direction (Dy) which intersects with the first direction (Dx) and the second end surfaces (21tb) adjacent in the second direction.

### TECHNICAL FIELD

The present invention relates to a reactor core, a reactor, and a method for manufacturing a reactor core.

Priority is claimed on Japanese Patent Application No. 2018-065177, filed Mar. 29, 2018, the content of which is incorporated herein by reference.

### BACKGROUND ART

Patent Document 1 describes a reactor mounted on a vehicle such as a hybrid vehicle or an electric vehicle. A reactor core of this reactor is formed of an I-shaped core formed by press-molding raw material powder containing soft magnetic powder, and an end core formed by press-molding raw material powder also containing soft magnetic powder.

### CITATION LIST

### Patent Document

Patent Document 1

Japanese Patent No. 2016-131200

### SUMMARY OF INVENTION

### Technical Problem

The reactor core described in Patent Document 1 is designed for mass production because the reactor core is used in a vehicle such as a hybrid vehicle or an electric vehicle. When the reactor core is mass-produced in this way, it is desirable to reduce the number of man-hours by reducing the number of core components that form one reactor core.

An inner core portion and an outer core portion described in Patent Document 1 are press-molded using different metal molds. For this reason, in the case of not mass production, the cost ratio by preparing a plurality of types of metal molds becomes large, and the productivity may decrease.

Further, in the case of producing a large reactor core, such as a reactor core used in a construction machine and used with a large current, a powder magnetic core, which is a core component of the reactor core, becomes large. When the powder magnetic core becomes large in this way, it may be difficult to press-mold the powder magnetic core.

An object of the present invention is to provide a reactor core, a reactor, and a method for manufacturing a reactor core which can be easily molded while restraining a decrease in productivity.

### Solution to Problem

According to an aspect of the present invention, a reactor core includes: a plurality of inner core portions configured to include a plurality of first powder magnetic cores, the first powder magnetic cores being arranged in line in a first direction and each including a first end surface and a second end surface on both sides in the first direction; and two outer core portions configured to include a second powder magnetic core corresponding to the first powder magnetic core in external dimensions, the second powder magnetic core being arranged between the first end surfaces adjacent to each other in a second direction intersecting with the first direction and between the second end surfaces adjacent to each other in the second direction.

### Advantageous Effects of Invention

According to the reactor core of the above aspect, the reactor core can be easily molded while restraining a decrease in productivity.

### BRIEF DESCRIPTION OF DRAWINGS

FIG. 1 is a circuit diagram of a step-up circuit according to one embodiment of the present invention.

FIG. 2 is a plan view of a reactor according to one embodiment of the present invention.

FIG. 3 is a plan view of a reactor core according to one embodiment of the present invention.

FIG. 4 is a side view of the reactor core mentioned above seen from a second direction.

FIG. 5 is a plan view of a first powder magnetic core according to one embodiment of the present invention seen from a third direction.

FIG. 6 is a side view of the first powder magnetic core mentioned above seen from a second direction.

FIG. 7 is a sectional view taken along the line VII-VII of FIG. 5.

FIG. 8 is a plan view of a second powder magnetic core according to one embodiment of the present invention seen from a third direction.

FIG. 9 is a side view of the second powder magnetic core mentioned above seen from a second direction.

FIG. 10 is a sectional view taken along the line X-X of FIG. 8.

FIG. 11 is a plan view of a coil attached to the reactor mentioned above.

FIG. 12 is a side view of a coil attached to the reactor mentioned above seen from a second direction.

FIG. 13 is a flow chart of a method for manufacturing reactor core and a method for manufacturing reactor according to one embodiment of the present invention.

FIG. 14 is a perspective view showing a state immediately before inserting the inner core portion into the coil.

FIG. 15 is a perspective view showing a state immediately before fixing an outer core portion to a second end portion of the inner core portion mentioned above.

FIG. 16 is a sectional view showing a state where a coil and a reactor placed on a metal mold.

FIG. 17 is a sectional view showing a state where an insulating member filled in a metal mold by injection molding.

### DESCRIPTION OF EMBODIMENTS

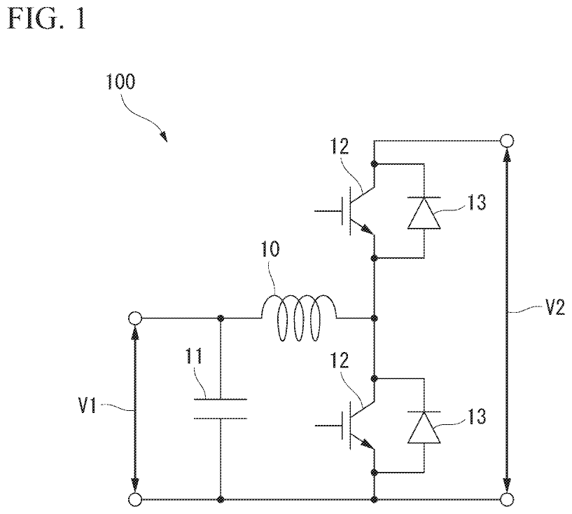

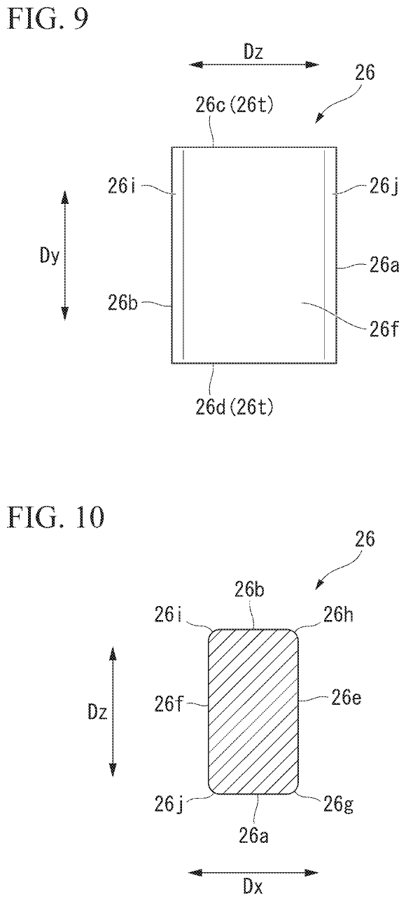

Hereinafter, embodiments of the present invention will be described in detail with reference to FIGS. 1 to 17.

Step-Up Circuit

As shown in FIG. 1, a reactor 10 according to the present embodiment constitutes a part of a step-up circuit 100. The step-up circuit 100 is a chopper type step-up circuit, and includes the reactor 10, a capacitor 11, and a power semiconductor 12 such as an IGBT. The step-up circuit 100 according to the present embodiment is built in an inverter that drives an electric motor mounted on a hybrid hydraulic excavator or the like, and steps up a terminal voltage V1 of a capacitor or the like to a voltage V2 required by the inverter. In FIG. 1, reference sign “13” denotes a free-wheeling diode.

Reactor

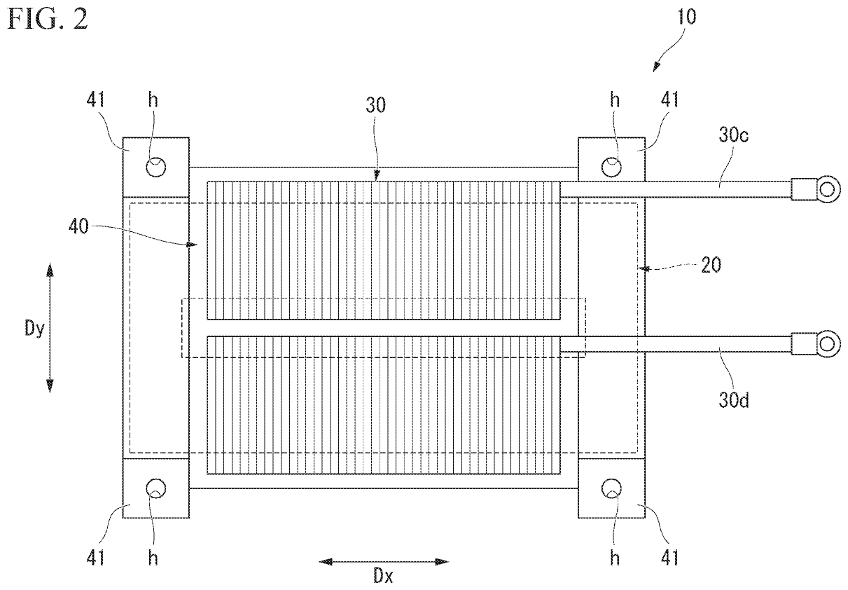

As shown in FIG. 2, the reactor 10 includes a reactor core 20, a coil 30, and an insulating member 40. Since the reactor 10 according to the present embodiment is a reactor used in a hybrid hydraulic excavator or the like, a large current flows through the reactor 10 as compared with a reactor used in a vehicle such as an automobile. Therefore, the reactor 10 according to the present embodiment is larger than the reactor used in a vehicle such as an automobile.

Reactor Core

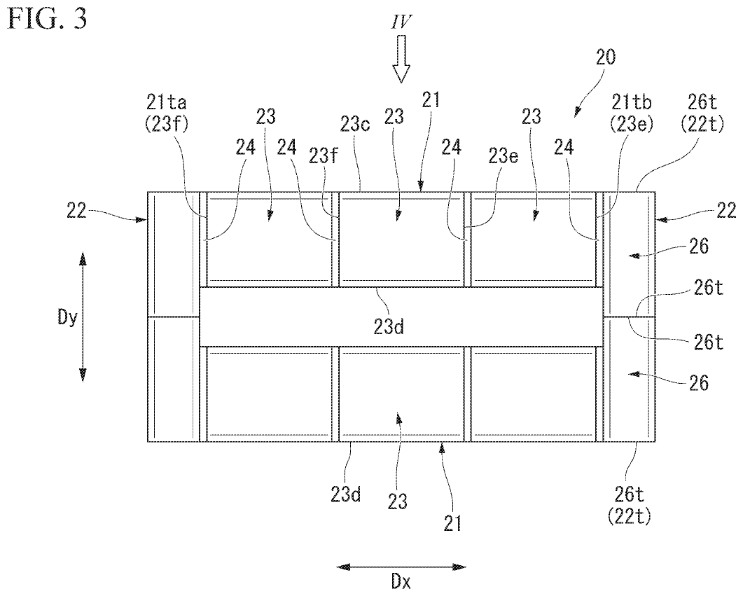

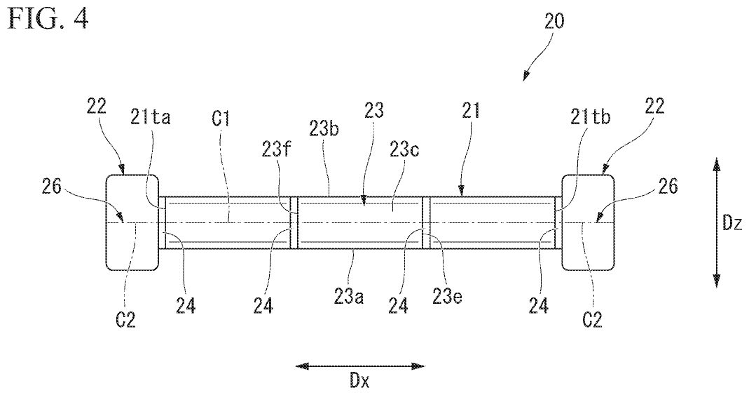

As shown in FIGS. 3 and 4, the reactor core 20 includes two inner core portions 21 and two outer core portions 22. In the following description, a first direction is defined as “Dx” and a second direction intersecting with the first direction is defined as “Dy”. A third direction intersecting with the first direction Dx and the second direction Dy is defined as “Dz”.

The two inner core portions 21 extend in the first direction Dx. The inner core portion 21 includes a first end surface 21ta and a second end surface 21tb on both sides in the first direction Dx. The two inner core portions 21 are arranged at interval in the second direction Dy intersecting with the first direction Dx. The two outer core portions 22 extend in the second direction Dy and are arranged at interval in the first direction Dx. The outer core portion 22 is arranged over the first end surfaces 21ta adjacent to each other in the second direction Dy, and is also arranged over the second end surfaces 21tb adjacent to each other in the second direction Dy.

The reactor core 20 has a ring shape including these two inner core portions 21 and two outer core portions 22.

The inner core portion 21 has a plurality of first powder magnetic cores 23 and a plurality of gap members 24. Each of the inner core portions 21 as shown in FIG. 3 has three first powder magnetic cores 23 and four gap members 24.

The plurality of first powder magnetic cores 23 are arranged in line in the first direction Dx. The first powder magnetic cores 23 are formed by press-molding raw material powder containing soft magnetic powder. The plurality of first powder magnetic cores 23 are respectively formed by using the same mold member or a plurality of mold members having the same shape. As the soft magnetic powder contained in the raw material powder, for example, powders of various alloys, pure iron and the like which are soft magnetic materials can be used.

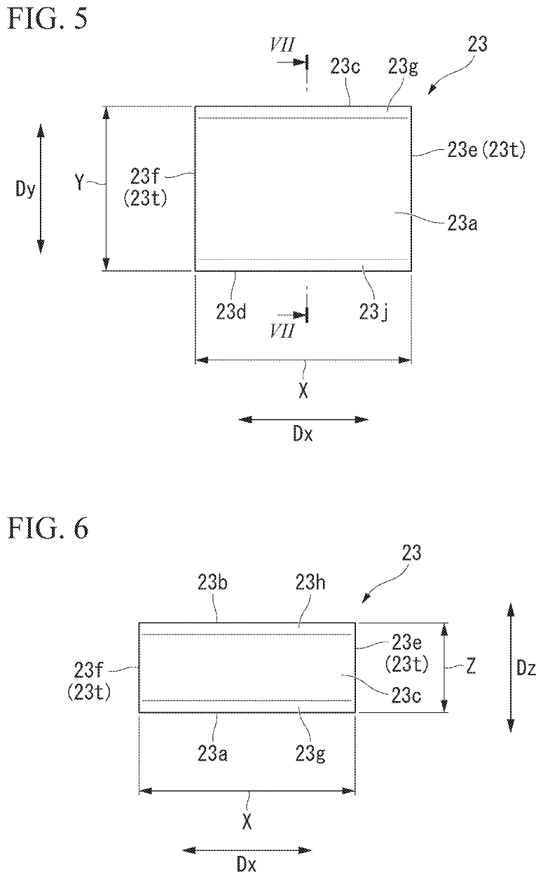

As shown in FIGS. 5 to 7, the first powder magnetic core 23 is substantially a cuboid. The first powder magnetic core 23 has a shape of cuboid that is long in the first direction Dx. The first powder magnetic core 23 has six planes, a first plane 23a to a sixth plane 23f. The first plane 23a and the second plane 23b are formed substantially in parallel and spread in a direction perpendicular to the third direction Dz. The third plane 23c and the fourth plane 23d are formed in parallel with each other and spread in a direction perpendicular to the second direction Dy. The fifth plane 23e and the sixth plane 23f are formed in parallel with each other and spread in a direction perpendicular to the first direction Dx. The fifth plane 23e and the sixth plane 23f form two end surfaces 23t of the first powder magnetic core 23 in the first direction Dx.

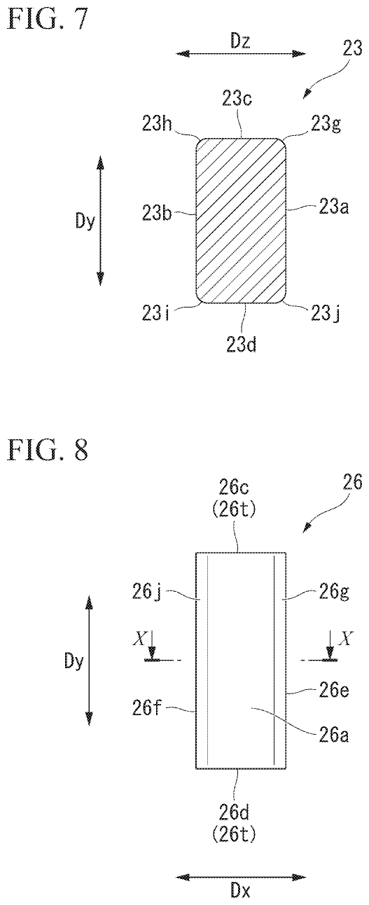

Each of four corner portions 23g, 23h, 23i, and 23j of the first powder magnetic core 23 extending in the first direction Dx is formed in a curved surface shape that is outwardly convex like chamfering. Therefore, the cross-sectional shape perpendicular to the first direction Dx in the first powder magnetic core 23 (see FIG. 7) has a nearly rectangular shape having four corner portions formed in an arc shape like chamfering, which is the same as that of the fifth plane 23e and the sixth plane 23f. As shown in FIGS. 5 and 6, the external dimensions of the first powder magnetic core 23 have the relationship Z<Y<X, when the length in the first direction Dx is defined as “X”, the length in the second direction Dy is defined as “Y”, and the length in the third direction Dz is defined as “Z”.

As shown in FIG. 4, in the one inner core portion 21, the three first powder magnetic cores 23 arranged in line in the first direction Dx respectively have the first planes 23a arranged flush with each other and the second planes 23b arranged flush with each other. Similarly, as shown in FIG. 3, in one inner core portion 21, the three first powder magnetic cores 23 arranged in line in the first direction Dx respectively have the third planes 23c arranged flush with each other and the fourth planes 23d arranged flush with each other.

As shown in FIGS. 3 and 4, the gap member 24 is arranged between the fifth plane 23e and the sixth plane 23f of the first powder magnetic core 23 adjacent in the first direction Dx. The fifth plane 23e and the gap member 24, and the sixth plane 23f and the gap member 24 are fixed by adhesive or the like, respectively. The gap member 24 is a spacer that puts a predetermined distance between the first powder magnetic cores 23 adjacent to each other in the first direction Dx. The gap member 24 is made of a non-magnetic material that has an excellent insulating property and a heat resisting property, such as ceramics, aluminum oxide (alumina), or a synthetic resin. The gap member 24 is formed in a flat plate shape, and has an outer shape that is slightly smaller than or equal to the shapes of the fifth plane 23e and the sixth plane 23f that are the end surfaces 23t of the first powder magnetic core 23 in plan view.

In the reactor core 20 illustrated in the present embodiment, the gap members 24 are arranged between the fifth plane 23e that is the second end surface 21tb of the inner core portion 21 and the outer core portion 22, and between the sixth plane 23f that is the first end surface 21ta of the inner core portion 21 and the outer core portion 22, respectively.

The total gap length of the reactor core 20 formed by the gap members 24 can be calculated according to conditions such as the saturation current value of the reactor core 20 and the maximum value of the current flowing through the coil 30. When the total gap length is constant, the thickness per gap member 24 is small as the number of the gap members 24 installed increases.

The outer core portion 22 has a second powder magnetic core 26. The outer core portion 22 shown in FIG. 3 has two second powder magnetic cores 26. These two second powder magnetic cores 26 are arranged in line in the second direction Dy. The second powder magnetic cores 26 adjacent to each other in the second direction Dy are fixed to each other by adhesion or the like. No member corresponding to the above-described gap member 24 is arranged between the second powder magnetic cores 26 adjacent to each other in the second direction Dy. In the present embodiment, the number (three) of the first powder magnetic cores 23 arranged in line in the first direction Dx is greater than the number (two) of the second powder magnetic cores 26 arranged in line in the second direction Dy.

As shown in FIGS. 3 and 4, the second powder magnetic core 26 is formed by press-molding raw material powder containing soft magnetic powder. The plurality of second powder magnetic cores 26 are respectively formed by using the same mold member as the mold member forming the first powder magnetic core 23 or another mold member having the same shape as a shape of the mold member forming the first powder magnetic core 23. The second powder magnetic core 26 differs from the first powder magnetic core 23 only in the arrangement direction, and the external dimension of the second powder magnetic core 26 corresponds to that of the first powder magnetic core 23. In other words, the second powder magnetic core 26 has substantially the same shape as the shape of the first powder magnetic core 23. The raw material powder forming the second powder magnetic core 26 according to the present embodiment uses the same kind of raw material powder as the raw powder forming the first powder magnetic core 23, but different raw powders may be used.

As shown in FIGS. 8 to 10, the second powder magnetic core 26 is substantially a cuboid as well as the first powder magnetic core 23. The second powder magnetic core 26 has a shape of cuboid that is long in the second direction Dy. The second powder magnetic core 26 has six planes, a first plane 26a to a sixth plane 26f The first plane 26a and the second plane 26b are formed in parallel with each other and spread in a direction that is perpendicular to the third direction Dz. The third plane 26c and the fourth plane 26d are formed in parallel with each other and spread in a direction that is perpendicular to the second direction Dy. The fifth plane 26e and the sixth plane 26f are formed in parallel with each other and spread in a direction that is perpendicular to the first direction Dx. The third plane 26c and the fourth plane 26d form two end surfaces 26t of the second powder magnetic core 26 in the second direction Dy.

Each of four corner portions 26g, 26h, 26i, and 26j of the second powder magnetic core 26 extending in the second direction Dy is formed in a curved surface shape that is outwardly convex like chamfering. Therefore, the cross-sectional shape perpendicular to the second direction Dy in the second powder magnetic core 26 (see FIG. 10) has a nearly rectangular shape having four corner portions formed in an arc shape like chamfering, which is the same as that of the third plane 26c and the fourth plane 26d.

As shown in FIG. 3, among the third planes 23c of the two inner core portions 21 arranged in parallel, the third plane 23c arranged on the outside in the second direction Dy and one end surface 26t of the outer core portion 22 are arranged flush with each other. Among the fourth planes 23d of the two inner core portions 21 arranged in parallel, the fourth plane 23d arranged on the outside in the second direction Dy and the other end surface 26t of the outer core portion 22 are arranged flush with each other. As shown in FIG. 4, the center position C1 of the inner core portion 21 and the center position C2 of the outer core portion 22 in the third direction Dz coincide with each other.

Coil

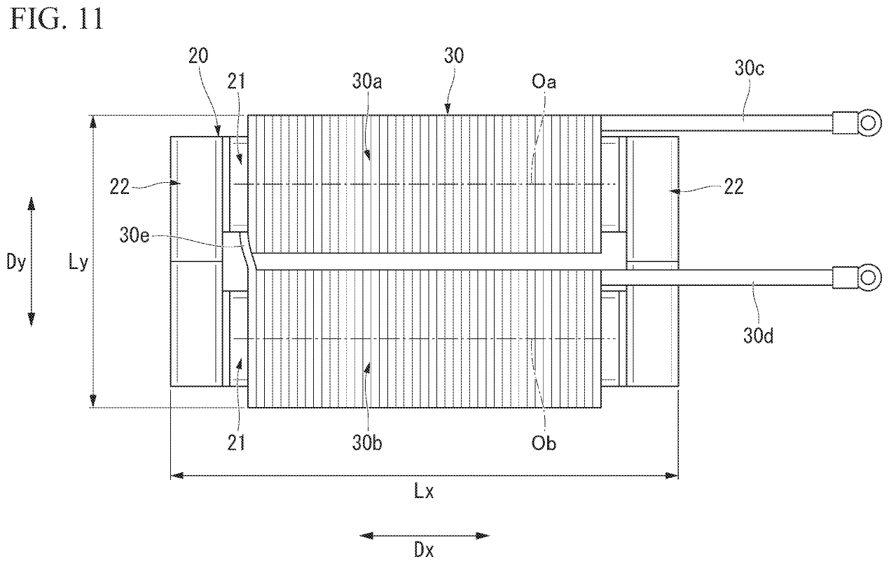

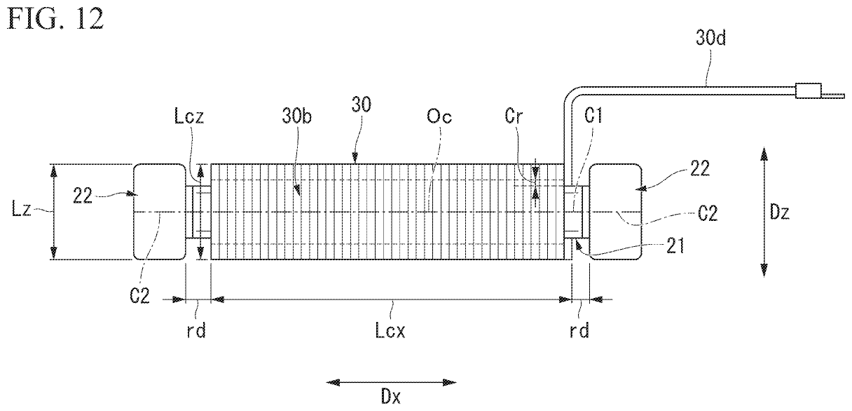

As shown in FIGS. 11 and 12, the coil 30 is formed by making a wire rod such as a copper wire into a solenoid shape wind. The coil 30 includes two tubular portions 30a and 30b formed in line in parallel. The tubular portions 30a and 30b are electrically connected in series and are respectively attached on the two inner core portions 21 arranged in parallel. The axes Oa and Ob of the tubular portions 30a and 30b extend in the first direction Dx. The leader lines 30c and 30d of the coil 30 are both arranged on one side in the first direction Dx. The wire rod 30e extending between the tubular portions 30a and 30b is arranged on the opposite side of the leader lines 30c and 30d in the first direction Dx. These two tubular portions 30a and 30b are wound around the inner core portion 21 by inserting the inner core portion 21, respectively. The wire rods that form the two tubular portions 30a and 30b are wound such that the directions of the lines of magnetic force inside the reactor core 20 formed in a ring shape when the coil 30 is energized are in the same direction.

As shown in FIG. 12, the external dimension Lcz of the coil 30 in the third direction Dz is set to a dimension corresponding to the external dimension Lz of the outer core portion 22 in the third direction Dz (in other words, substantially the same dimension). When the coil 30 is placed on a plane so that the third direction Dz coincides with the vertical direction, the center Oc of the coil 30 in the third direction Dz, the center position C1 of the inner core portion 21 in the third direction Dz, and the center position C2 of the outer core portion 22 in the third direction Dz are arranged substantially on the same plane. Gaps Cr are respectively formed between the tubular portion 30a and the inner core portion 21 arranged inside the tubular portion 30a, and between the tubular portion 30b and the inner core portion 21 arranged inside the tubular portion 30b around the entire circumference of the inner core portion 21.

Insulating Member

The insulating member 40 shown in FIG. 2 electrically insulates between the reactor core 20 and the coil 30. As the insulating member 40, a synthetic resin having excellent insulation performance and a heat-resisting property can be used. The thickness and quality of material of the insulating member 40 may be selected according to the required insulation performance and a heat-resisting property. The insulating member 40 according to the present embodiment is formed so as to cover the entire reactor core 20.

Structural Condition of Reactor

As shown in FIG. 11, the dimension (length) of the reactor 10 excluding the insulating member 40 in the first direction Dx (hereinafter, simply referred to as the reactor 10) is defined as “Lx”, and the dimension (width) of the reactor 10 in the second direction Dy is defined as “Ly”. As shown in FIG. 12, the dimension (height or thickness) of the reactor 10 in the third direction Dz is defined as “Lz”. The total gap length of the gap member 24 is defined as “t1” (not shown), the sum of the size of the gap Cr that is the insulation distance between the coil 30 and the inner core portion 21 and the wire diameter of the wire rod of the coil 30 is defined as “t2” (not shown), and the sum of the length Lcx of the coil 30 in the first direction Dx and the sum (rd×2) of the insulation distance rd that is the distance between the coil 30 and the outer core portion 22 is defined as “t3” (not shown). Further, assuming that the dimensions of the first powder magnetic core 23 are “X”, “Y”, and “Z” shown in FIGS. 5 to 7 mentioned above, the structural conditions of the reactor 10 can be expressed by the following expressions.

Lx=2Z+3X+t½

Ly=2X+2t2

Lz=Y=Z+2t2

The condition that the tubular portions 30a and 30b of the coil 30 wound around the two inner core portions 21 do not interfere with each other can be expressed by the following expression.

2X>2Y+2t2

The condition of the length of the inner core portion 21 in the first direction Dx can be expressed by the following expression.

3X+t½>t3

(Method for Manufacturing Reactor Core and Method for Manufacturing Reactor)

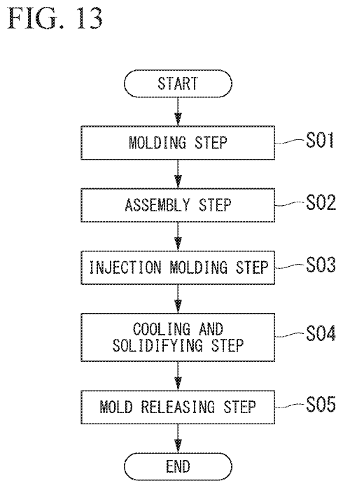

Next, a method for manufacturing the reactor core will be described with reference to FIGS. 13 to 17.

First, raw material powder containing the same soft magnetic powder is press-molded using the same mold member or a plurality of mold members having the same shape (none of which are shown), and a plurality of first powder magnetic cores 23 and a plurality of second powder magnetic cores 26 are formed (step S01; molding step). All the powder magnetic cores molded by the above-mentioned mold members have substantially the same shape (corresponding external dimensions). Therefore, the powder magnetic core immediately after being molded by the mold member may not be distinguish between the first powder magnetic core 23 and the second powder magnetic core 26 as core components. In the present embodiment, the powder magnetic core immediately after being molded by the mold member is managed and stored without distinction between the first powder magnetic core 23 and the second powder magnetic core 26.

Even if the same mold member or the mold member having the same shape is used, a slight difference in shape may occur between the first powder magnetic core 23 and the second powder magnetic core 26. The above-mentioned “substantially the same shape” and “corresponding external dimensions” mean that even if such a slight difference in shape occurs, they are regarded as the same shape.

Next, the reactor core 20 is assembled by combining the above-mentioned powder magnetic cores (step S02; assembly step).

Specifically, first, the two inner core portions 21 are assembled by using the powder magnetic cores molded by the above-mentioned mold members as the first powder magnetic cores 23. At this time, the gap member 24 is put between the first powder magnetic cores 23 and fixed by adhesion or the like. Similarly, the outer core portions 22 are assembled using the powder magnetic cores molded by the above-mentioned mold members as the second powder magnetic cores 26. At this time, the gap member 24 is not put between the end surfaces 26t of the two second powder magnetic cores 26 that are arranged to face each other in the second direction Dy, and these two end surfaces 26t are directly fixed by adhesion or the like.

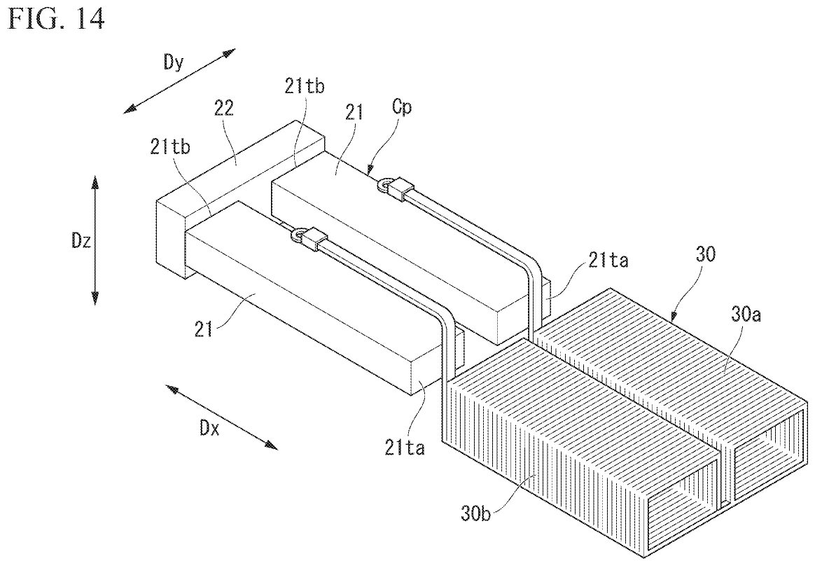

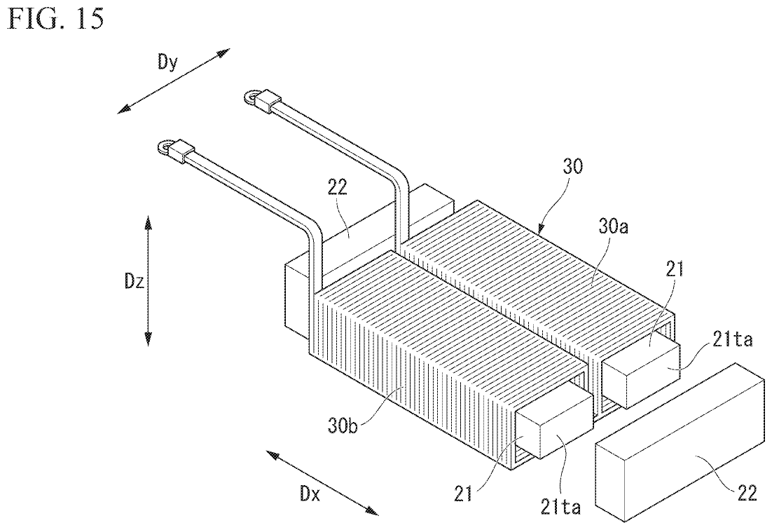

Next, the reactor core 20 is assembled by using the two inner core portions 21 and the two outer core portions 22. The coil 30 is attached during the assembly of the reactor core 20. As shown in FIGS. 14 and 15, in the present embodiment, a core component Cp having U-shape is formed by fixing the second end surfaces 21tb of the two inner core portions 21 to one outer core portion 22 by adhesion or the like. As shown in FIG. 15, the inner core portions 21 of the core component Cp formed in U-shape are inserted into the two tubular portions 30a and 30b of the coil 30, respectively. Thereafter, the fifth plane 26e or the sixth plane 26f of the other outer core portion 22 is fixed to the first end surfaces 21ta on the open side of the two inner core portions 21 by adhesion or the like.

By fixing the inner core portion 21 and the outer core portion 22, the reactor core 20 formed in a ring shape by the two inner core portions 21 and the two outer core portions 22 to which the coil 30 is attached is completed. The procedure for attaching the coil 30 described in the present embodiment is an example, and is not limited to the above-mentioned procedure.

Next, the insulating member 40 is placed between the reactor core 20 and the coil 30.

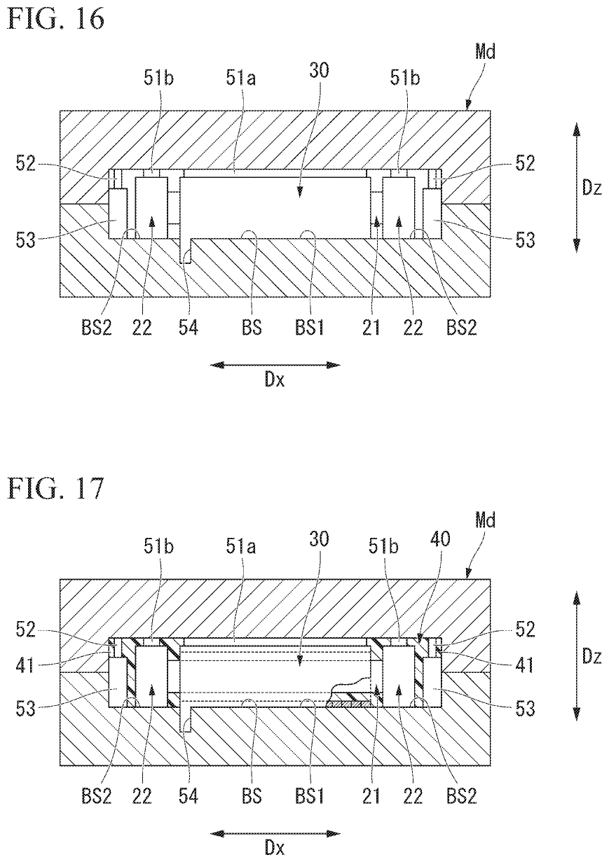

Specifically, as shown in FIGS. 16 and 17, the reactor core 20 and the coil 30 are installed in an injection molding metal mold Md in an orientation in which the third direction Dz extends upward and downward. The bottom surface BS inside the metal mold Md includes a first support portion BS1 that supports the coil 30 from below, and a second support surface B S2 that supports the outer core portion 22 of the reactor core 20 from below. The first supporting surface BS1 and the second support surface BS2 form a plane where the positions in the third direction Dz are substantially the same. The bottom surface BS of the metal mold Md in the present embodiment is a substantially continuous horizontal surface including the first supporting surface B S1 and the second support surface BS2.

By installing the reactor core 20 and the coil 30 on the bottom surface BS, the position of the surface facing downward of the outer core portion 22 (in other words, the first plane 26a or the second plane 26b of the second powder magnetic core 26) and the position of the bottom edge of coil 30 are arranged at substantially the same position in the third direction Dz. Therefore, as mentioned above, the center Oc of the coil 30, the center position C1 of the inner core portion 21, and the center position C2 of the outer core portion 22 are arranged substantially on the same plane. In this way, by arranging the centers Oc, C1, and C2 on substantially the same plane, the gap Cr between the tubular portion 30a and the inner core portion 21 (see FIG. 12) is formed symmetrically in the third direction based on the center position.

Next, the metal mold Md is closed, the material of the insulating member 40 that has been heated and melted in the metal mold Md is injected, and at least the gap Cr between the reactor core 20 and the coil 30 is filled with the material of the insulating member 40 (step S03: injection molding step).

The insulating member 40 according to the present embodiment is formed so as to cover the entire outer surface of the reactor core 20. As shown in FIGS. 2, 16, and 17, the insulating member 40 according to the present embodiment includes mounting hole forming portions 41 at the four corners seen from the third direction Dz. These mounting hole forming portions 41 include mounting holes h for fixing the reactor 10 to a case of an inverter and the like or installing a heat sink.

In FIGS. 16 and 17, reference sign “51a” indicates a pressing member that presses the coil 30 to prevent the coil 30 from moving in the metal mold Md. The pressing member 51a presses the coil 30 from above. Reference sign “51b” indicates each pressing member that presses the reactor core 20 to prevent the reactor core 20 from moving in the metal mold Md. The pressing members 51b press the outer core portions 22 from above. Reference sign “52” indicates a collar for forming the mounting hole h. The collar 52 is formed, for example, in a cylindrical shape and is removed after injection molding. A mounting hole h penetrating in the third direction Dz is formed in the mounting hole forming portion 41 by removing the collar 52.

Reference sign “53” is a collar presser foot. The collar presser foot 53 supports the collar 52 from below. Reference sign “54” indicates a groove for letting out the leader lines 30c and 30d of the coil 30. In the present embodiment, the groove 54 is formed on the bottom surface BS. When injection molding is performed, the leader lines 30c and 30d are inserted into the groove 54. The pressing members 51a and 51b, the collar 52, and the collar presser foot 53 are not limited to the above-mentioned shapes and arrangements. The pressing members 51a and 51b, the collar 52, and the collar presser foot 53 may be determined according to various conditions such as the specifications of the reactor 10 and the shape of the metal mold Md.

Next, the insulating member 40 is cooled and solidified (step S04; cooling and solidifying step), the metal mold Md is opened, and the reactor 10 is taken out (step S05; mold releasing step).

### Action and Effect

As described above, in the reactor core 20 according to the present embodiment, the inner core portion 21 is formed by arranging the plurality of first powder magnetic cores 23 in the first direction Dx, and the outer core portion 22 is formed from the second powder magnetic core 26 that corresponds to the first powder magnetic core 23 in terms of the external dimensions. In this case, since the first powder magnetic core 23 and the second powder magnetic core 26 can be press-molded by using the same mold member or the mold member having the same shape, it is possible to suppress a decrease in productivity due to an increase in cost accompanying with an increase in kinds of mold members. Furthermore, in the reactor core 20 according to the present embodiment, the inner core portion 21 is formed from the three first powder magnetic cores 23, and the outer core portion 22 is formed from the two second powder magnetic cores 26. Therefore, it is possible to prevent the core component forming the reactor core 20 from increasing in size, and the core component can be easily molded without using a dedicated large-sized press device or the like.

The inner core portion 21 according to the present embodiment includes the gap member 24 between the first powder magnetic cores 23 adjacent to each other in the first direction Dx, respectively. Therefore, gaps can be installed in a plurality of places on the reactor core 20. In this case, since the total gap length required for the reactor core 20 can be distributed to a plurality of places, the performance of the reactor 10 is improved by reducing the leakage flux as compared with the case where the gap is installed in only one place.

The first powder magnetic core 23 according to the present embodiment has a shape of cuboid that is long in the first direction Dx. The second powder magnetic core 26 has a shape of cuboid that is long in the second direction Dy. Therefore, the shapes of the first powder magnetic core 23 and the second powder magnetic core 26 can be made simple. The first powder magnetic core 23 and the second powder magnetic core 26 form a shape of cuboid so that the end surface 23t of the first powder magnetic core 23, which is a plane, can be arranged to face the fifth plane 26e or the sixth plane 26f of the second powder magnetic core 26, which is a plane. Therefore, it is possible to prevent the cross-sectional area of the magnetic path of the reactor core 20 formed in a ring shape from becoming small.

The cross-sectional shape of the first powder magnetic core 23 perpendicular to the first direction Dx in the present embodiment is a rectangular shape that is long in the second direction Dy. Therefore, the dimension of the inner core portion 21 in the third direction Dz can be reduced without changing the cross-sectional area of the magnetic path as compared with the case where the cross-sectional shape perpendicular to the first direction Dx of the first powder magnetic core 23 is, for example, a square or the like.

The cross-sectional shape of the second powder magnetic core 26 perpendicular to the second direction Dy in the present embodiment is a rectangular shape that is long in the third direction Dz. Therefore, the dimension of the outer core portion 22 in the first direction Dx can be reduced without changing the cross-sectional area of the magnetic path as compared with the case where the cross-sectional shape of the second powder magnetic core 26 perpendicular to the second direction Dy is a square or the like.

Therefore, it is possible to miniaturize the reactor 10 by reducing the dimension in the first direction Dx and the dimension in the third direction Dz of the reactor core 20.

In the present embodiment, the center position C1 of the first powder magnetic core 23 and the center position C2 of the second powder magnetic core 26 in the third direction Dz coincide with each other. Since the dimension of the outer core portion 22 is larger than the dimension of the inner core portion 21 in the third direction Dz, it is possible to form a space for arranging the coil 30 that is further dented in the third direction Dz than the third plane 26c and the fourth plane 26d of the outer core portion 22 on both sides of the inner core portion 21 in the third direction Dz.

In the reactor core 20 according to the present embodiment, the number of the first powder magnetic cores 23 arranged in line in the first direction Dx is greater than the number of the second powder magnetic cores 26 arranged in line in the second direction Dy. Therefore, the reactor core 20 in which the dimension in the second direction Dy is less than the dimension in the first direction Dx can be easily formed.

In the reactor 10 according to the present embodiment, the external dimension Lcz of the coil 30 in the third direction Dz is a dimension corresponding to the external dimension Lz of the outer core portion 22 in the third direction Dz. By doing so, when the positions of the end surface 22t of the outer core portion 22 and the outer peripheral surface of the coil 30 in the third direction Dz coincide with each other, the center position C1 of the inner core portion 21 and the position of the center Oc of the coil 30 in the third direction Dz coincide with each other. Therefore, by placing the reactor core 20 and the coil 30 on the same plane in the third direction Dz in the vertical direction, the gap Cr between the inner core portion 21 and the coil 30 is formed symmetrically in the third direction Dz based on the center position C1 of the inner core portion 21.

In the method for manufacturing the reactor core 20 according to the present embodiment, a plurality of powder magnetic cores are formed using the same mold member or a plurality of mold members having the same shape in the molding step, and the reactor core 20 is assembled by combining a plurality of powder magnetic cores corresponding to the external dimensions, respectively in the assembly step. Therefore, each of the inner core portion 21 and the outer core portion 22 of the reactor core 20 can be formed by using, as the first powder magnetic core 23 and the second powder magnetic core 26, the powder magnetic cores having the corresponding external dimensions and having substantially the same shape. As a result, it is not necessary to prepare different kinds of mold members, and the kinds of mold members do not increase. Therefore, it is possible to prevent the core components forming the reactor core 20 from getting larger. Therefore, it is possible to suppress a decrease in productivity and to easily perform molding.

In the method for manufacturing the reactor 10 according to the present embodiment, the reactor core 20 and the coil 30 are installed in the metal mold in an orientation in which the third direction Dz extends upward and downward, and the insulating member 40 is filled at least between the reactor core 20 and the coil 30 by injection molding. Thereby, even after the reactor core 20 is assembled, the insulating member 40 can be easily filled between the reactor core 20 and the coil 30.

### OTHER EMBODIMENTS

The embodiments of the present invention have been described above, but the present invention is not limited thereto, and can be appropriately modified without departing from the technical idea of the invention.

In the embodiment, the example in which the present invention is applied to the step-up circuit 100 of the hybrid hydraulic excavator has been described, but it may be applied to another step-up circuit.

Although the reactor core 20 of the embodiment has the two inner core portions 21, it may have three or more inner core portions 21.

In the second direction Dy, the third plane 23c arranged outside the two inner core portions 21 arranged in parallel and one end surface 26t of the outer core portion 22 are arranged flush with each other. In the second direction Dy, the fourth plane 23d arranged outside the two inner core portions 21 arranged in parallel and the other end surface 26t of the outer core portion 22 are arranged flush with each other. However, the third plane 23c and one end surface 26t, and the fourth plane 23d and the other end surface 26t may not be arranged flush with each other.

The insulating member 40 according to the embodiment is formed by filling a synthetic resin between the coil 30 and the reactor core 20 by injection molding. However, the insulating member 40 is not limited to that formed by injection molding, and for example, a bobbin or the like formed so as to cover the outer peripheral surface of the inner core portion 21 may be used.

The curved surface formed on the second powder magnetic core 26 according to the embodiment, which is convex outward such as the chamfer may be provided as necessary and may be omitted.

### INDUSTRIAL APPLICABILITY

According to the reactor core mentioned above, the reactor core can be easily molded while restraining a decrease in productivity.

### DESCRIPTION OF SYMBOLS

10 . . . Reactor 11 . . . Capacitor 12 . . . Power semiconductor 20 . . . Reactor core 21 . . . Inner core portion 21ta . . . First end surface 21tb . . . Second end surface 22 . . . Outer core portion 22t . . . End surface 23 . . . First powder magnetic core 23a . . . First plane 23b Second plane 23c . . . Third plane 23d . . . Fourth plane 23e . . . Fifth plane 23f . . . Sixth plane 23t . . . End surface 23g, 23h, 23i, 23j . . . Corner portion 24 . . . Gap member 26 . . . Second powder magnetic core 26a . . . First plane 26b . . . Second plane 26c . . . Third plane 26d . . . Fourth plane 26e . . . Fifth plane 26f . . . Sixth plane 26t . . . End surface 26g, 26h, 26i, 26j . . . Corner portion 30 . . . Coil 30a, 30b . . . Tubular portion 30c, 30d . . . Leader line 40 . . . Insulating member 41 . . . Mounting hole forming portion 100 . . . Step-up circuit h . . . Mounting hole Md . . . Metal mold

1. A reactor core comprising:
a plurality of inner core portions configured to include a plurality of first powder magnetic cores, the first powder magnetic cores being arranged in line in a first direction and each including a first end surface and a second end surface on both sides in the first direction; and
two outer core portions configured to include a second powder magnetic core corresponding to the first powder magnetic core in external dimensions, the second powder magnetic core being arranged between the first end surfaces adjacent to each other in a second direction intersecting with the first direction and between the second end surfaces adjacent to each other in the second direction.

2. The reactor core according to claim 1, further comprising:
a gap member arranged at at least a plurality of positions between the first powder magnetic cores adjacent to each other in the first direction and forming a gap between the first powder magnetic cores adjacent to each other in the first direction.

3. The reactor core according to claim 1, wherein the first powder magnetic core has a shape of cuboid that is long in the first direction, and the second powder magnetic core has a shape of cuboid that is long in the second direction.

4. The reactor core according to claim 3, wherein the first powder magnetic core has a cross-sectional shape perpendicular to the first direction, the cross-sectional shape having a rectangular shape that is long in the second direction, and the second powder magnetic core has a cross-sectional shape perpendicular to the second direction, the cross-sectional shape having a rectangular shape that is long in a third direction intersecting with the first direction and the second direction.

5. The reactor core according to claim 4, wherein a center position of the first powder magnetic core and a center position of the second powder magnetic core in the third direction coincide with each other.

6. The reactor core according to claim 1, wherein the number of the first powder magnetic cores arranged in line in the first direction is greater than the number of the second powder magnetic cores arranged in line in the second direction.

7. A reactor comprising:
the reactor core according to claim 1; and
a coil wound in a tubular shape around the inner core.

8. The reactor according to claim 7, wherein an external dimension of the coil in a third direction intersecting with the first direction and the second direction is a dimension corresponding to an external dimension of the outer core portion in the third direction.

9. A method for manufacturing a reactor core, the method comprising:
forming a plurality of powder magnetic cores having a shape of cuboid by using a same mold member or a plurality of mold members having the same shape; and
combining and assembling the plurality of powder magnetic cores having a shape of cuboid formed by using the mold member.
